(19) United States
(12) Patent Application Publication
(10) Pub. No.: US 2016/0327176 A1
(43) Pub. Date: Nov. 10, 2016

(54) ELECTROMAGNETIC ACTUATOR AND SOLENOID-VALVE DEVICE

(71) Applicant: HONDA MOTOR CO., LTD., Tokyo (JP)

(72) Inventor: Hirotomi NEMOTO, Wako-shi (JP)

(73) Assignee: HONDA MOTOR CO., LTD., Tokyo (JP)

(21) Appl. No.: 15/110,376

(22) PCT Filed: Dec. 25, 2014
(86) PCT No.: PCT/JP2014/084242

§ 371 Date: Jul. 7, 2016

(30) Foreign Application Priority Data
Jan. 21, 2014 (JP) 2014-009027

(51) Int. Cl. F16K 31/08; H01F 7/16; F16K 31/06

(52) U.S. Cl. CPC F16K 31/082; F16K 31/0679; F16K 31/0631; H01F 7/1615

(57) ABSTRACT

An electromagnetic actuator is provided that can achieve reduction in size, weight and cost by a simple configuration, and a solenoid-valve device provided therewith. The electromagnetic actuator section includes fixed pole pieces that a middle of three fixed magnetic poles has, and coils wound around the fixed pole pieces. The coils are wound in the same winding direction. The needle has first and second stabilization points corresponding to the fixed magnetic poles on both sides in the axial direction, and a third stabilization point corresponding to the middle fixed magnetic pole, as stabilization points at which a stationary state can be maintained when the coil is unenergized.

### TECHNICAL FIELD

The present invention relates to an electromagnetic actuator including a cylindrical stator and a needle that reciprocates inside the stator in the axial direction and a solenoid-valve device including the electromagnetic actuator.

### BACKGROUND ART

Conventionally, a hydraulic control unit structured to switch hydraulic pressure in an oil passage for hydraulic control using a solenoid valve is employed as a means for changing gear stages of an automatic transmission. The solenoid valve in this case has a valve structure of the normally open type or the normally closed type, configured to apply electricity (electric current or voltage) to the solenoid valve to perform an operation necessary for switching the oil passage.

In the prior arts, it is necessary to continuously apply electricity to the solenoid valve to produce hydraulic pressure necessary for the oil passage for hydraulic control. Further, as a transmission is more staged in recent years, one unit of transmission tends to have a larger number of installed solenoid valves. This causes a problem that an increase in electric power consumption required for speed control contributes to deterioration of fuel efficiency of a vehicle.

As a conventional art for addressing this problem, a solenoid-valve device (self-holding valve) disclosed in Patent Document 1 is available. In the solenoid-valve device described in Patent Document 1, three fixed magnetic poles are arranged with a gap between each other, and a magnetization coil is disposed therebetween. The fixed magnetic poles on both sides are connected in the same polarity, and the fixed magnetic pole in the middle therebetween and the fixed magnetic poles on both sides are connected in opposite polarities, whereby the three fixed magnetic poles have the polarities: N—S—N or S—N—S. Thus, when a magnetization coil is unenergized, the valve body is biased to a valve seat at a closing position of a valve body by attractive force between a permanent magnet and the fixed magnetic poles. This configuration can achieve reduction of electric power consumption as electricity should be applied to the solenoid-valve device only at the time of switching opening and closing of the oil passage.

However, in the solenoid-valve device disclosed in Patent Document 1, a needle (armature) of an electromagnetic actuator is composed only of magnet. Thus, the needle without any iron core could deteriorate magnetic reluctance around the coil degenerates in a magnetic field generated from a coil of a stator, possibly leading to deterioration of magnetic circuit efficiency.

Moreover, in the solenoid-valve device disclosed in Patent Literature 1, the coil of the stator is wound to surround the needle and wound around a shaft center of the needle. Furthermore, two coils wound in opposite directions to each other are conductive with each other in series. This configuration has a problem that increase in number of turns of the coils causes increase in volume and weight of the coils and the stators due to low magnetic circuit efficiency.

Moreover, in the solenoid-valve device disclosed in Patent Literature 1, when no coil is energized, the needle can be held (stopped) in a way to abut on each of top and bottom stoppers, but cannot be held in a middle position between the top and bottom stopper sections. Therefore, this solenoid-valve device can switch hydraulic pressure of hydraulic fluid circulating in the oil passage only in two stages.

### RELATED ART DOCUMENTS

### Patent Documents

[Patent Document 1] Japanese Unexamined Patent Application Publication No. 05-87267.

### DISCLOSURE OF THE INVENTION

### Problems to be Solved by the Invention

The present invention was made in view of an above-mentioned point, and the purpose is to provide an electromagnetic actuator that can achieve reduction in size, weight and cost by a simple configuration, and a solenoid-valve device provided therewith.

### Means of Solving the Problems

In order to solve the above-described problems, an electromagnetic actuator in accordance with the present invention includes a cylindrical stator (31) and a needle (50) that reciprocates inside the stator (31) in the axial direction. The stator (50) includes three fixed magnetic poles (41, 42, 43) arranged with a gap between each other in the axial direction and a coil (45) for exciting the stator (31). The needle (50) includes a shaft member (51) that can reciprocate in the axial direction, a permanent magnet (52) fixed to the shaft member (51) and magnetized axially, and a pair of magnetic members (61, 62) installed on both sides of the permanent magnet (52) in the axial direction. The fixed magnetic pole (43), the middle one of the three fixed magnetic poles (41, 42, 43) in the arrangement direction, has fixed pole pieces (43a, 43b, 43c) projecting towards a shaft center of the needle (50) from a cylindrical frame part (44). Coils (45a, 45b, 45c) are wound around the fixed pole pieces (43a, 43b, 43c). A plurality of sets of the fixed pole pieces (43a, 43b, 43c) and the coils (45a, 45b, 45c) is arranged on an outer periphery of the needle (50). The coils (45) of the sets are wound in a same winding direction. The needle (50) has first and second stabilization points (L1-1, L1-2) corresponding to the fixed magnetic poles (41, 42) on both sides in the axial direction, and a third stabilization point (L1-3) corresponding to the middle fixed magnetic pole (43), as stabilization points at which a stationary state can be maintained when the coil (45) is unenergized.

According to the electromagnetic actuator of the present invention, the needle has the first and second stabilization points corresponding to the fixed magnetic poles on both sides in the axial direction, and a third stabilization point corresponding to the middle fixed magnetic pole, as stabilization points at which a stationary state can be maintained when the coil is unenergized, whereby the needle can be held at the above-described first, second and third stabilization points. And, since voltage should be applied to the coil only when the needle is moved from one stabilization point to another stabilization point, a larger reduction in electric power consumption is enabled in comparison with a conventionally-structured electromagnetic actuator.

In addition, according to the electromagnetic actuator in accordance with the present invention, the needle is configured to include the permanent magnet and the pair of magnetic members installed on both sides of the permanent magnet in the axial direction, whereby the magnetic field generated from the permanent magnet and the coil passes through the magnetic material. Thus, in comparison with the conventional electromagnetic actuator including the needle provided only with the permanent magnet, the electromagnetic actuator of the present invention can have an air gap of a smaller dimension between the stator and the needle and accordingly achieve larger improvement in magnetic circuit efficiency. Therefore, magnetic reluctance (around the coil) due to the magnetic field generated from the coil of the stator is improved to better magnetic circuit efficiency.

Moreover, in the electromagnetic actuator according to the present invention, the middle one of the three fixed magnetic poles in the arrangement direction has the fixed pole pieces projecting towards the shaft center of the needle from the cylindrical frame part; the coils are wound around these fixed pole pieces; the plurality of sets of these fixed pole pieces and the coils is arranged on the outer periphery of the needle; and the coils of the sets are wound in the same winding direction. This leads to higher magnetic circuit efficiency of the stator, enabling to achieve reduction in the number of turns of the coil, simplification of the configuration of the electromagnetic actuator and reduction in size, weight and cost thereof.

Furthermore, the above-described electromagnetic actuator should include a first locking means (71) for locking the needle (50) biased towards the first stabilization point (L1-1) at a position before the first stabilization point (L1-1), and a second locking means (72) for locking the needle (50) biased towards the second stabilization point (L1-2) at a position before the second stabilization point (L1-2).

According to this configuration, the above-described first and second locking means can lock the needle biased towards the first and second stabilization points at the position therebefore. Thus, the needle can be held stably while magnetic force is applied from the stator to the needle.

Moreover, the solenoid-valve device (1) in accordance with the present invention includes the electromagnetic actuator (30) of the above-described configuration, and a valve part (10) for switching opening and closing of an oil passage (2) where hydraulic fluid circulates by driving the electromagnetic actuator (30). The valve part (10) includes a valve seat part (8) installed in the oil passage (2), and a valve body (3) that is driven by the needle (50) to be seated on the valve seat part (8). When the needle (50) is at the first stabilization point (L1-1), or at the first locking position (L2-1) locked by the first locking means (71), the valve body (3) is seated on the valve seat part (8) at a closing position at which the oil passage (2) is closed. When the needle (50) is at the second stabilization point (L1-2), or at the second locking position (L2-2) locked by the second locking means (72), the valve body (3) is at an opening position at which the valve body is spaced from the valve seat part (8) to open the oil passage (2). When the needle (50) is at the third stabilization point (L1-3), the valve body (3) is at the middle position between the closing position and the opening position.

According to the solenoid-valve device in accordance with the present invention, the electromagnetic actuator of the above-described configuration, with which the solenoid-valve device is provided, can achieve simplification and reduction in size, weight and cost of the configuration of the solenoid-valve device that can switch opening and closing of the oil passage where hydraulic fluid circulates. In addition, the valve body is at the closing position at which the oil passage is closed when the needle is at the first stabilization point or at the first locking position, the valve body is at the opening position at which the oil passage is opened when the needle is at the second stabilization point or at the second locking position, and the valve body is at the middle position between the closing position and the opening position when the needle is at the third stabilization point, whereby hydraulic pressure of hydraulic fluid that circulates in the oil passage can be switched to three stages. It should be noted that the above characters in parentheses represent, by way of example, reference characters of components of an embodiment to be described hereinafter.

### Effects of the Invention

The electromagnetic actuator in accordance with the present invention and the solenoid-valve device provided therewith can achieve reduction in size, weight and cost by a simple configuration.

### BRIEF DESCRIPTION OF THE DRAWINGS

FIG. 1A and FIG. 1B are views illustrating an exemplary configuration of a solenoid-valve device in accordance with one embodiment of the present invention, of which FIG. 1A is a sectional side view of the solenoid-valve device, and FIG. 1B is a schematic sectional view of a part corresponding to an A-A arrow view of FIG. 1A;

FIG. 2 is a view for illustrating how the electromagnetic actuator section operates;

FIG. 3 is a graph showing change in voltage applied to a coil and hydraulic pressure in an oil passage; and

FIG. 4 is a view for illustrating switching opening and closing of an oil passage using a solenoid-valve device.

### MODE FOR CARRYING OUT THE INVENTION

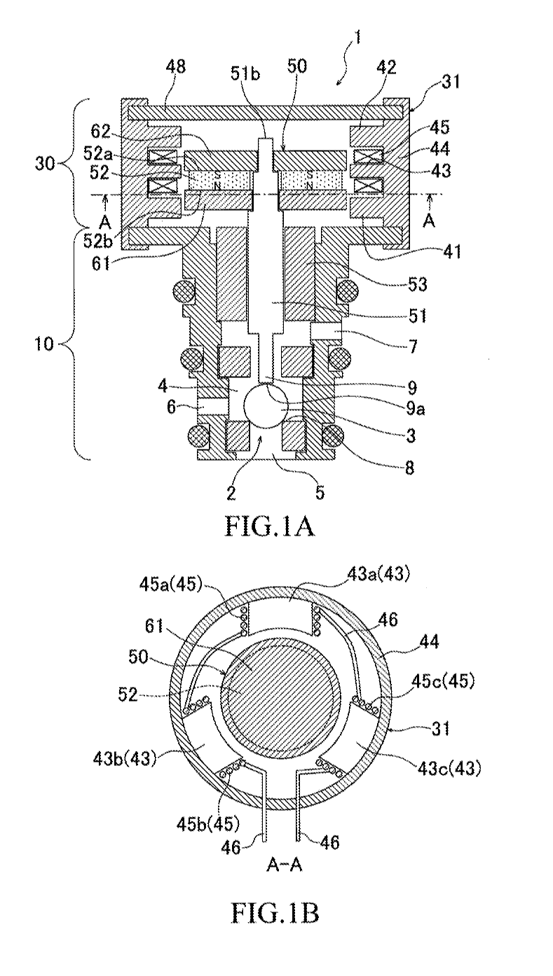

Hereinafter, an embodiment of the present invention will be described in detail with reference to the appending drawings. FIG. 1A and FIG. 1B are views illustrating an exemplary configuration of a solenoid-valve device oil according to one embodiment of the present invention, of which FIG. 1A is a sectional side view of the solenoid-valve device, and FIG. 1B is a schematic sectional view of a part corresponding to an A-A arrow view of FIG. 1A. The solenoid-valve device 1 shown in the same figure is mounted in a hydraulic control unit of an automotive automatic transmission, and a device for stitching opening and closing of the oil passage, with which the hydraulic control device is provided, where control hydraulic fluid circulates. This solenoid-valve device 1 includes a valve part 10 provided with a ball valve (valve body) 3 for switching opening and closing of the oil passage 2, and an electromagnetic actuator section (electromagnetic actuator) 30 for driving the ball valve 3.

A valve chamber 4 accommodating the ball valve 3, an inflow port 5 at which hydraulic fluid flows into the valve chamber 4, an outflow port 6 at which hydraulic fluid flows from the valve chamber 4 and a discharge port 7 communicating to a hydraulic pressure release section (not shown in the figure) from the valve chamber 4 are provided in the oil passage 2. In addition, around the inflow port 5 inside the valve chamber 4, a valve seat part 8 for seating the ball valve 3 to close the oil passage 2 is provided. The valve seat section 8 is a circular annular section for seating the ball valve 3. While the oil passage 2 is closed by seating the ball valve 3 to the valve seat part 8, the oil passage 2 is opened by spacing the ball valve 3 from the valve seat part 8.

Moreover, the valve part 10 includes a rod-shaped plunger 9 for pressing the ball valve 3 towards the valve seat part 8. A bottom side of the plunger 9 is connected integrally to a shaft member 51, which will be described later, of the electromagnetic actuator section 30. A part of the plunger 9 on a tip 9a side thereof is arranged inside the valve chamber 4, and the tip 9a presses the ball valve 3 for driving the plunger.

The electromagnetic actuator section 30 includes a stator 31 substantially cylindrical in shape and the needle 50 that reciprocates in the axial direction (vertical direction in FIG. 1A) inside the stator 31. The stator 31 has three fixed magnetic poles, namely, a first fixed magnetic pole 41, a second fixed magnetic pole 42 and a third fixed magnetic pole 43 made of magnetic materials, which are arranged inside with a gap between each other in the axial direction, and a coil 45 for exciting the three fixed magnetic poles 41, 42, 43. Outer peripheries of the three fixed magnetic poles 41, 42, 43 are connected with each other on a cylindrical frame part 44.

The needle 50 includes a shaft member 51 arranged inside the three fixed magnetic poles 41, 42, 43 provided by the stator 31 and reciprocatable in the axial direction, a permanent magnet 52 fixed to the shaft member 51 and magnetized in the axial direction, and a pair of iron cores, namely, a first iron core 61 and a second iron core 62 (magnetic members), installed on both sides of the permanent magnet 52 in the axial direction. In other words, in the needle 50, the permanent magnet 52 and the pair of iron cores 61, 62 are fixed to the shaft member 51, and the shaft member 51, the permanent magnet 52 and the pair of iron cores 61, 62 are held so as to reciprocate along the axial direction inside the stator 31. The permanent magnet 52 is magnetized in the axial direction so that one end face 52a thereof in the axial direction (or an end face on the opposite side of the valve part 10) is the S-pole, and another end face (or an end face on the valve part 10 side) 52b is the N-pole. In addition, the shaft member 51 is supported by a bearing 53.

The needle 50 of the above-described configuration is configured to stroke in the axial direction between a position at which the tip 9a of the plunger 9 presses the ball valve 3 to abut to the valve seat part 8 and a position at which a rear end 51b of the shaft member 51 abuts to a bottom plate 48.

As shown in FIG. 1B, the third fixed magnetic pole 43, which is middle one of the three fixed magnetic poles 41, 42, 43 in the arrangement direction (axial direction), has three fixed pole pieces 43a, 43b. 43c projecting from an inner surface of the cylindrical frame part 44 towards the shaft center of the needle 50. The three fixed pole pieces 43a, 43b, 43c are arranged on an outer periphery of the needle 50 at a regular interval (an interval of 120 degrees). And, coils (winding wires) 45 (45a, 45b, 45c) are wound around the fixed pole pieces 43a, 43b, 43c. Namely, three sets of the fixed pole pieces 43a-43c and the coils 45a-45c are arranged on the outer periphery of the needle 50. And, the coils 45a-45c are wound in the same winding direction. The coils 45a-45c are connected in series to each other via a wiring 46. Therefore, the coils 45a-45c are wound in the same winding direction as a connection direction of the wiring 46.

Both ends of the wiring 46 connecting the coils in series are connected to a DC power supply (not shown in the figure). By applying voltage from the DC power supply, the first fixed magnetic pole 41 and the second fixed magnetic pole 42 on both sides are magnetized with the same polarity. The third fixed magnetic pole 43 in the middle is magnetized with a polarity opposite to the first fixed magnetic pole 41 and the second fixed magnetic pole 42 on both sides. When voltage application to the coil 45 is cancelled, the magnetization of the first, second and third fixed magnetic poles 41, 42, 43 vanishes.

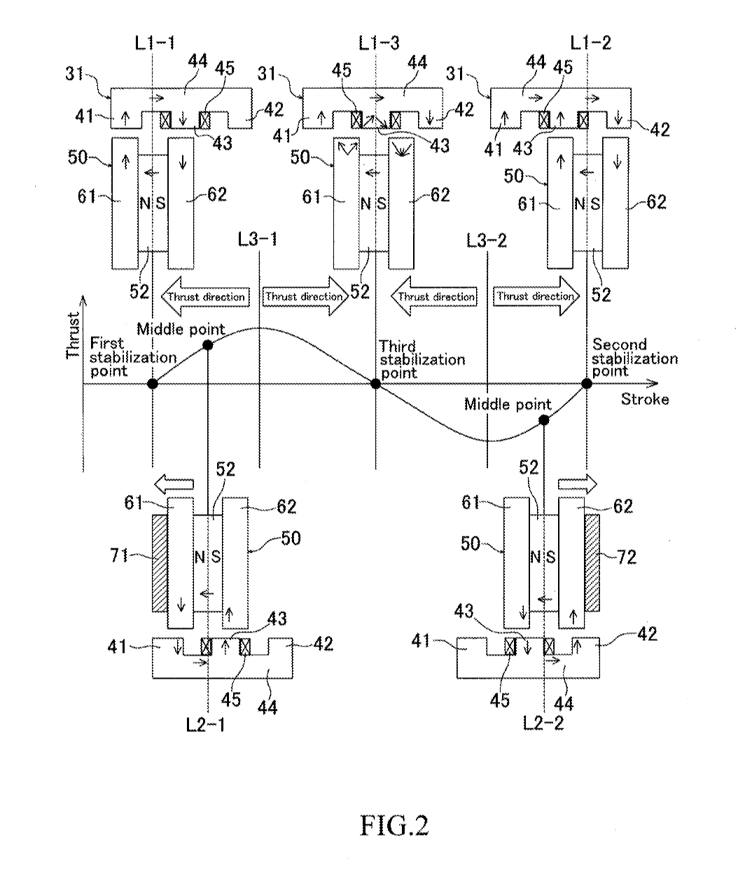

FIG. 2 is a view for illustrating how the electromagnetic actuator section operates. In this figure, magnetic directions inside the stator 31 (composed of the frame part 44 and the fixed magnetic poles 41, 42, 43) and the needle 50 (composed of the permanent magnet 52 and the iron cores 61, 62) at each stabilization point are shown by arrows. In the electromagnetic actuator section 30 of this embodiment, the needle 50 has first and second stabilization points L1-1, L1-2 corresponding to the fixed magnetic poles 41, 42 on both sides in the axial direction, and a third stabilization point L1-3 corresponding to the middle fixed magnetic pole 43, as stabilization points at which a stationary state can be maintained when the coil 45 is unenergized.

Namely, at the first stabilization point L1-1, the first iron core 61 of the needle 50 faces the first fixed magnetic pole 41 of the stator 31, and the second iron core 62 of the needle 50 faces the third fixed magnetic pole 43 of the stator 31. Due to this, magnetic lines of force running from the N-pole of the permanent magnet 52 flow from the first iron core 61 to the first fixed magnetic pole 41, then flow from the first fixed magnetic pole 41 via the neighboring frame part 44 to the third fixed magnetic pole 43, and then returns from the third fixed magnetic pole 43 via the second iron core 62 to the S-pole of the permanent magnet 52. Such loop of the magnetic lines of force can stably hold the needle 50 (composed of the permanent magnet 52 and the iron cores 61, 62) at this first stabilization point L1-1.

Next, at the second stabilization point L1-2, the first iron core 61 of the needle 50 faces the third fixed magnetic pole 43 of the stator 31, and the second iron core 62 of the needle 50 faces the second fixed magnetic pole 42 of the stator 31. Due to this, magnetic lines of force running from the N-pole of the permanent magnet 52 flow from the first iron core 61 to the third fixed magnetic pole 43, then flow from the third fixed magnetic pole 43 via the neighboring frame part 44 to the second fixed magnetic pole 42, and then returns from the second fixed magnetic pole 42 via the second iron core 62 to the S-pole of the permanent magnet 52. Such loop of the magnetic lines of force can stably hold the needle 50 (composed of the permanent magnet 52 and the iron cores 61, 62) at this second stabilization point L1-2.

And next, at the third stabilization point L1-3, the first iron core 61 of the needle 50 faces a middle position between the first fixed magnetic pole 41 of the stator 31 and the third fixed magnetic pole 43 thereof, and the second iron core 62 of the needle 50 faces a middle position between the third fixed magnetic pole 43 of the stator 31 and the second fixed magnetic pole 42 thereof. Due to this, magnetic lines of force running from the N-pole of the permanent magnet 52 flow from the first iron core 61 to the first fixed magnetic pole 41 and the second fixed magnetic pole 42, then flow from the first fixed magnetic pole 41 and the second fixed magnetic pole 42 via the neighboring frame part 44 to the third fixed magnetic pole 43 and the second fixed magnetic pole 42, and then returns from the third fixed magnetic pole 43 and the second fixed magnetic pole 42 via the second iron core 62 to the S-pole of permanent magnet 52. Such loop of the magnetic lines of force can stably hold the needle 50 (composed of the permanent magnet 52 and the iron cores 61, 62) at this third stabilization point L1-3.

And, in order to move the needle 50 from the first stabilization point L1-1 to the second stabilization point L1-2 or the third stabilization point L1-3, positive direct current is applied to the coil 45 of the needle 50. Then, due to voltage applied by this direct current to the coil 45, magnetic force occurs for moving the needle 50 (composed of the permanent magnet 52 and the iron cores 61, 62) from first stabilization point L1-1 to the second stabilization point L1-2 side or the third stabilization point L1-3 side, whereby the needle 50 moves to the second stabilization point L1-2 or the third stabilization point L1-3. The magnetic force upon energization becomes smaller as the needle 50 moves by this magnetic force, and the magnetic force vanishes at the second stabilization point L1-2 or the third stabilization point L1-3, whereby the needle 50 becomes stable. It should be noted that also in order to move the needle 50 at third stabilization point L1-3 to the second stabilization point L1-2, positive direct current is applied to the coil 45 of the needle 50.

Similarly, in order to move the needle 50 at the second stabilization point L1-2 to the first stabilization point L1-1 or the third stabilization point L1-3, negative direct current is applied to the coil 45 of the needle 50. Then, due to voltage applied by the direct current to the coil 45, magnetic force occurs for moving the needle 50 (composed of the permanent magnet 52 and the iron cores 61, 62) from the second stabilization point L1-2 to the first stabilization point L1-1 side or the third stabilization point L1-3 side, whereby the needle 50 moves to the first stabilization point L1-1 or the third stabilization point L1-3. The magnetic force upon energization becomes smaller as the needle 50 moves by this magnetic force, and the magnetic force vanishes at the first stabilization point L1-1 or the third stabilization point L1-3, whereby the needle 50 becomes stable. It should be noted that also in order to move the needle 50 at third stabilization point L1-3 to the first stabilization point L1-1. negative direct current is applied to the coil 45 of the needle 50.

In this manner, a thrust direction of the needle 50 can be arbitrarily set to control thrust of the needle 50 by limiting the area of the magnetic field generated to the needle 50 and the stator 31 from the coil 45, using changes in magnetic reluctance between the same and opposite directions of the magnetic field generated to the stator 31 and the needle 50 from the coil 45 with respect to a direction of the magnetic field generated by the permanent magnet 52 to the stator 31 and the needle 50.

Additionally, at the middle stabilization point L3-1 between the first stabilization point L1-1 and the third stabilization point L1-3, the thrust direction of the needle 50 switches between the first stabilization point L1-1 direction and the third stabilization point L1-3 direction. Similarly, at the middle stabilization point L3-2 between the second stabilization point L1-2 and the third stabilization point L1-3, the thrust direction of the needle 50 switches between the second stabilization point L1-2 direction and the third stabilization point L1-3 direction.

And, if a locking means (first locking means 71) is provided for locking the needle 50 that moves to the first stabilization point L1-1 direction at a position at which thrust is provided to the needle 50, between the first stabilization point L1-1 and the third stabilization point L1-3, in the first stabilization point L1-1 direction (position on the stabilization point L1-1 side first from the middle position L3-1), the needle 50 is locked (held) at that position under load (biasing force) in the first stabilization point L1-1 direction. Hereinafter, this position is referred to as a first locking position L2-1. Similarly, if a locking means (second locking means 72) is provided for locking the needle 50 that moves to the second stabilization point L1-2 direction at a position at which thrust is provided to the needle 50, between the second stabilization point L1-2 and the third stabilization point L1-3, in the second stabilization point L1-2 direction (position on the second stabilization point L1-2 side from the middle position L3-2), the needle 50 is locked (held) at that position under load (biasing force) in the second stabilization point L1-2 direction. Hereinafter, this position is referred to as a second locking position L2-2.

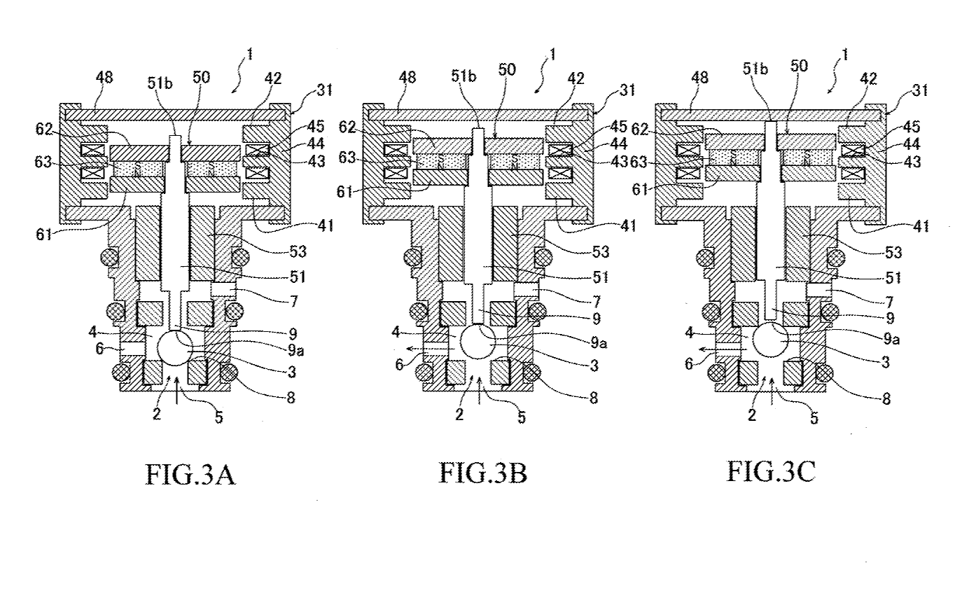

Next, switching operations of the oil passage 2 using the solenoid-valve device 1 will be described. FIGS. 3A to 3C are views illustrating operations of the solenoid-valve device 1, of which FIG. 3A shows a closing position at which the ball valve 3 is seated on the valve seat part 8 to close the oil passage 2. FIG. 3B shows an opening position at which the ball valve 3 is spaced from the valve seat part 8 to open the oil passage 2, and FIG. 3C shows a middle position of the ball valve 3 between the closing position and the opening position.

In the solenoid-valve device 1 of the present embodiment, a movement to the valve part 10 side in the axial direction of the needle 50 is locked at a position at which the tip 9a of the plunger 9 presses the ball valve 3 to abut to the valve seat part 8 (see FIG. 3A). Therefore, the first locking means 71 for locking the needle 50 that moves in the first stabilization point L1-1 direction is configured by the tip 9a of the plunger 9, the ball valve 3 and the valve seat part 8 (see FIG. 2). On the other hand, when the tip 9a of the plunger 9 is spaced from the ball valve 3, a rear end 51b of the shaft member 51 abuts to the bottom plate 48a, thereby locking a movement of the needle 50 to the opposite side of the valve part 10 in the axial direction (see FIG. 3C). Therefore, the second locking means 72 for locking the needle 50 that moves to the second stabilization point L1-2 direction is composed of the rear end 51b of the shaft member 51 and the bottom plate 48 (see FIG. 2).

In other words, the solenoid-valve device 1 of this embodiment is configured so that the ball valve 3 is seated on the valve seat part 8 when the needle 50 is at a position before (or immediately before) the first stabilization point L1-1, and consequently the movement of the needle 50 to the valve part 10 side is locked at this position to close the oil passage 2. Similarly, the solenoid-valve device 1 of this embodiment is configured so that the rear end 51b of the shaft member 51 abuts on the bottom plate 48 when the needle 50 is at a position before (or immediately before) the second stabilization point L1-2, and consequently the movement of the needle 50 to the opposite side of the valve part 10 is locked at this position to open the oil passage 2. Therefore, the first locking position L2-1 of FIG. 2 corresponds to the condition that the ball valve 3 in the solenoid-valve device 1 is seated on the valve seat part 8, and the second locking position L2-2 of FIG. 2 corresponds to the condition that the rear end 51b of the shaft member 51 in the solenoid-valve device 1 abuts to the bottom plate 48.

Therefore, in order to close the oil passage 2 using the solenoid-valve device 1, the needle 50 is moved towards the first stabilization point L1-1 by applying an electric current to the coil 45 (energized state of the coil 45 is ON) while the needle 50 is at the second stabilization point L1-2 or at the third stabilization point L1-3. Thus, the tip 9a of the plunger 9 abuts to and then presses the ball valve 3. And, the plunger 9 stops at the position (first locking position L2-1) at which the ball valve 3 is seated (abuts) on the valve seat part 8. In this condition that the oil passage 2 is closed by this ball valve 3, no hydraulic pressure is applied to the outflow port 6 side (a hydraulic pressure of 0). Hereinafter, this condition is referred to as “closed state”.

On the other hand, in order to open the oil passage 2, the needle 50 is moved towards the second stabilization point L1-2 by applying an electric current to the coil 45 (energized state of the coil 45 is ON) while the needle 50 is at the stabilization point L1-1 first or at the third stabilization point L1-3. And, the plunger 9 (needle 50) stops at the position (second locking position L2-2) at which the rear end 51b of the shaft member 51 abuts to the bottom plate 48. At this position, the tip 9a of the plunger 9 is spaced from the ball valve 3. Thus, hydraulic pressure of the hydraulic fluid flowing into the valve chamber 4 from the inflow port 5 leads to the condition that the ball valve 3 is spaced from the valve seat part 8 and the oil passage 2 is opened (fully open state). In this condition, hydraulic pressure (maximum hydraulic pressure) P1 is applied to the outflow port 6 side. Hereinafter, this condition is referred to as “open state”.

On the other hand, in order to apply hydraulic pressure Pm lower than hydraulic pressure P1 of the above-described open state to the outflow port 6 side (P1>Pm), the needle 50 is moved to the third stabilization point L1-3 by applying an electric current to the coil 45 (energized state of the coil 45 is ON) while the needle 50 is at the first stabilization point L1-1. This leads to the condition, as shown in FIG. 3C, that while the tip 9a of the plunger 9 abuts to and presses the ball valve 3, the pressed ball valve 3 is not seated on (or does not abut to) the valve seat part 8 (or spaced therefrom). In this condition, while the oil passage 2 is not closed due to the ball valve 3 unseated on the valve seat part 8, a diameter dimension (channel cross-sectional area) of the oil passage 2 is smaller in comparison with a diameter dimension in the above-described open state (fully open state). Therefore, hydraulic pressure Pm lower than the maximum hydraulic pressure P1 is applied to the outflow port 6 side.

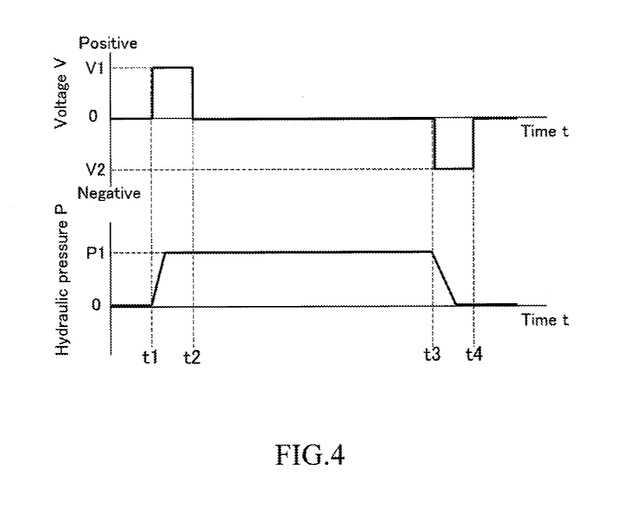

FIG. 4 is a graph illustrating relations between voltage V applied to the coil 45 of the electromagnetic actuator section 30 and hydraulic pressure P in the oil passage 2 (outflow port 6). In the solenoid-valve device 1 of this embodiment, as shown in the graph of the same figure, by applying voltage V1 (V1>0) to the coil at time t1 in the condition that hydraulic pressure P in the oil passage 2 is 0 (closed state of the oil passage 2), the oil passage 2 is opened and then hydraulic pressure P becomes P1. And, since the oil passage 2 can be held open even after canceling application of voltage V1 at time t2, hydraulic pressure P1 is maintained. On the other hand, applying voltage V2 (V2<0) to the coil at time t3 at hydraulic pressure P1 (or in open state of the oil passage 2), the oil passage 2 is closed and the hydraulic pressure P in the oil passage 2 becomes 0. And, since the closed state of the oil passage 2 can be maintained even after canceling application of voltage V2 at time t4, hydraulic pressure P is held at 0.

In other words, voltage is applied to the coil 45 only when the needle 50 is moved to switch opening and closing of the oil passage 2. And, even after canceling application of voltage, the closed state of the oil passage 2 can be maintained. In this manner, since voltage should be applied to the coil 45 only when the needle 50 is moved to switch opening and closing of oil passage 2, the electromagnetic actuator and solenoid-valve device of the present invention can achieve more significant reduction of electric power consumption in comparison with an electromagnetic actuator and solenoid-valve device of the conventional configuration (a normally opened type or normally closed type solenoid-valve device).

As described above, according to the electromagnetic actuator section 30 with which the solenoid-valve device 1 of this embodiment is provided, the needle 50 has the three stabilization points, namely, the first and second stabilization points L1-1, L1-2 corresponding to the fixed magnetic poles 41, 42 on both sides in the axial direction, and the third stabilization point L1-3 corresponding to the fixed magnetic pole 43 in the middle therebetween, as stabilization points at which the stationary state can be maintained when the coil 45 is unenergized. Consequently, the needle 50 can be held stably at the above-described three places, namely, the first stabilization point L1-1, the second stabilization point L1-2 and the third stabilization point L1-3. And, since voltage should be applied to the coil 45 only when the needle 50 is moved from one stabilization point to another stabilization point, the electromagnetic actuator of the present invention can achieve more significant reduction of electric power consumption in comparison with the electromagnetic actuator of the conventional configuration.

Moreover, according to the electromagnetic actuator section 30 with which the solenoid-valve device 1 of this embodiment is provided, the needle 50 is configured to include the permanent magnet 52 and the pair of iron cores (magnetic members) 61, 62 installed on both sides of the permanent magnet 52 in the axial direction, whereby the magnetic fields generated from the permanent magnet 52 and the coil 45 pass the iron cores 61, 62. In this way, in comparison with the conventional electromagnetic actuator including the needle 50 only provided with the permanent magnet 52, the electromagnetic actuator of this embodiment can minimize the dimension of an air gap between the stator 31 and the needle 50, achieving more significant improvement of magnetic circuit efficiency. Therefore, magnetic reluctance due to the magnetic field generated from the coil 45 of the stator 31 (reluctance circling around the coil 45) can improve to enhance magnetic circuit efficiency.

Furthermore, in the electromagnetic actuator section 30 of this embodiment, the fixed magnetic pole 43, which is the middle one of the three fixed magnetic poles 41, 42, 43 in the arrangement direction (axial direction), has the fixed pole pieces 43a-43c projecting towards the shaft center of the needle 50 from the cylindrical frame part 44. The coils 45a-45c are wound around these fixed pole pieces 43a-43c, the plurality of sets of these fixed pole pieces 43a-43c and the coils 45a-45c is arranged on the outer periphery of the needle 50, and the coils 45a-45c of each set are wound in the same winding direction. This enhances the magnetic circuit efficiency of the stator 31, contributing to reduction in the winding number of the coil 45 and allowing to achieve simplification of the configuration of the electromagnetic actuator section 30 as well as reduction in size, weight and price thereof.

Further, the above-described electromagnetic actuator section 30 includes the first locking means 71 for locking the needle 50 biased towards the first stabilization point L1-1 at a position before the first stabilization point L1-1 and the second locking means 72 for locking the needle 50 biased towards the second stabilization point L1-2 at a position before the second stabilization point L1-2, thereby allowing to lock the needle 50 biased towards the first and second stabilization points L1-1, L1-2 at the positions therebefore. This can hold the needle 50 stably under biasing force generated by the magnetic force of the permanent magnet 52.

In addition, according to the solenoid-valve device 1 of this embodiment, provision of the electromagnetic actuator section 30 of the above-mentioned configuration therewith can achieve simplification of the configuration of the solenoid-valve device 1 that can switch opening and closing of the oil passage 2 where hydraulic fluid circulates, as well as reduction in size, weight and price thereof. And, the ball valve 3 is at the closing position for closing the oil passage 2 when the needle 50 is at the first stabilization point L1-1 or the first locking position L2-1, the ball valve 3 is at the opening position for opening the oil passage 2 when the needle 50 is at the second stabilization point L1-2 or the second locking position L2-2, and the ball valve 3 is at the middle position between the closing position and the opening position when the needle 50 is at the third stabilization point L1-3, thereby allowing to switch hydraulic pressure of hydraulic fluid circulating in the oil passage 2 to the three stages.

While the embodiments of the invention have been described, it is to be understood that the invention is not limited to the foregoing embodiments. Rather, the invention can be modified to incorporate any number of variations or alterations within the scope of claims and the scope of technical concept described in the specification and the drawings thereof. In the solenoid-valve device 1 of the above-mentioned embodiment, the valve body 3 is at the closing position at which the valve body 3 is seated on the valve seat part 8 to close the oil passage 2 when the needle 50 is locked at the first locking position L2-1 by the first locking means 71, and the valve body 3 is at the opening position at which the valve body 3 is spaced from the valve seat part 8 to open the oil passage 2 when the needle 50 is locked at the second locking position L2-2 by the second locking means 72. Alternatively, as another embodiment of the solenoid-valve device in accordance with the present invention, the solenoid-valve device may be configured so that the valve body 3 is at the closing position at which the valve body 3 is seated on the valve seat part 8 to close the oil passage 2 when the needle 50 is at the first stabilization point L1-1, and the valve body 3 is at the opening position at which the valve body 3 is spaced from the valve seat part 8 to open the oil passage 2 when the needle 50 is at the second stabilization point L1-2, though full illustration and detailed description thereof is omitted.

1-3. (canceled)

4. An electromagnetic actuator comprising:
a cylindrical stator; and
a needle that reciprocates in the axial direction inside the stator,
wherein the stator comprising;
three fixed magnetic poles arranged with a gap in the axial direction; and
a coil for exciting the stator,
wherein the needle comprising:
a shaft member reciprocatable in the axial direction;
a permanent magnet fixed to the shaft member and magnetized in the axial direction; and
a pair of magnetic members installed on both sides of the permanent magnet in the axial direction,
wherein the fixed magnetic pole in a middle of the three fixed magnetic poles in an arrangement direction has a fixed pole piece projecting towards a shaft core of the needle from a cylindrical frame part,
wherein the coil is wound around the fixed pole piece, a plurality of a set of the fixed pole piece and the coil is arranged on an outer periphery of the needle,
wherein the coil of each set is wound in a same winding direction, and
wherein the needle has first and second stabilization points corresponding to the fixed magnetic poles on both sides in the axial direction, and a third stabilization point corresponding to the middle fixed magnetic pole, as stabilization points at which a stationary state can be maintained when the coil is unenergized.

5. The electromagnetic actuator according to claim 4 comprising:
a first locking means for locking the needle biased towards the first stabilization point at a point before the first stabilization point; and
a second locking means for locking the needle biased towards the second stabilization point at a point before the second stabilization point.

6. A solenoid-valve device comprising:
the electromagnetic actuator according to claim 5; and
a valve part for switching opening and closing of an oil passage where hydraulic fluid circulates by driving of the electromagnetic actuator,
wherein the valve part comprising:
a valve seat part installed in the oil passage; and
a valve body to be seated on the valve seat part by driving by the needle,
wherein the valve body is at a closing position at which the valve body is seated on the valve seat part to close the oil passage when the needle is locked at the first locking position by the first locking means, the valve body is at an opening position at which the valve body is spaced from the valve seat part to open the oil passage when the needle is locked at the second locking position by the second locking means, and the valve body is at a middle position between the closing position and the opening position when the needle is at the third stabilization point.
